(19) United States
(12) Patent Application Publication
(10) Pub. No.: US 2007/0097410 A1
(43) Pub. Date: May 3, 2007

(54) Information processing apparatus having a function restriction release function

(75) Inventor: Makoto Norimoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/360,886

(22) Filed: Feb. 23, 2006

(30) Foreign Application Priority Data
Nov. 1, 2005 (JP) JP2005-318625

(51) Int. Cl. G06K 15/00

(52) U.S. Cl. 358/1.14; 358/1.15

(57) ABSTRACT

An information processing apparatus which has a predetermined function in usage restriction condition, the apparatus including: a first obtaining section to obtain a first release information; a second obtaining section to obtain a second release information; an inverse-transformation section to process the second release information by using a inverse-transformation inverse to a predetermined transformation so as to generate a third release information; a comparison section which compare the third release information with the first release information; and a release section to release the predetermined function in usage restriction condition in case the third release information matches the first release information.

### RELATED APPLICATION

This application is based on Japanese Patent Application No. 2005-318625 filed with Japan Patent Office on Nov. 1, 2005, the entire content of which is hereby incorporated by reference.

### BACKGROUND

1. Field of the Technology

The present invention relates to an information processing apparatus incorporating predetermined functions placed under usage restriction, particularly to the technique of releasing this usage restriction.

2. Description of the Related Art

In an image processing apparatus called a multi functional apparatus containing a scanner function, printer function, facsimile function and other functions integrated into a copying machine, each of these functions may be put on the market separately according to individual requirements.

However, if the image processing apparatus production line must be modified to conform to the function to be sold, the apparatus production efficiency will be reduced. To solve this problem, it is possible to propose a method of manufacturing an image processing apparatus that incorporates the devices corresponding to all the functions in advance. Then some software means can be provided to apply usage restriction in such a way as to disable the devices providing the functions not purchased by a user.

Even if the functions not purchased by the user have come to be required later, this method allows such functions (hereinafter referred to as “optional functions”) to be used merely by a simple operation of releasing the usage restriction.

Usage restriction on the optional function can be imposed by disabling the operation program that operates the devices providing such functions. One of the techniques proposed to disable a program is to arrange a control circuit, for example, before a storage section and to restrict the access to the program inside the storage section. This control circuit receives the password inputted from the outside. Only when the password has matched the reference password stored by the password in advance, access to the program inside the storage section is enabled (Patent Document 1).

[Patent Document 1] Unexamined Japanese Patent Application Publication No. H06-309529

When inputting the password matching the reference password stored in advance, and releasing the usage restriction of optional function, the image processing apparatus manufacturer is required to manage the password to be inputted. This management is not very simple. To solve this problem, a common password is used for all the optional functions of the image processing apparatus, thereby making the password management less complicated. However, once the password has leaked, it can be easily copied and may be used for illegal release of the usage restriction of other apparatuses. This raises serious security problems.

If a unique password is set up for each optional function of each image processing apparatus, particular usage restrictions to be released are identified. This procedure prevents illegal use of the password. In this case, however, an enormous amount of passwords have to be placed under management. Since not all the users purchase the optional function, some of the passwords will never be used. This means a waste of time and labor used for password management.

### SUMMARY

The object of the present invention is to solve the aforementioned problems and to provide an information processing apparatus and function restriction release method that prevent illegal release of usage restriction of a predetermined function, and ensure easy management of the information used for release of usage restriction.

In view of foregoing, an object of this invention is to solve at least one of the problems, and to provide new information processing apparatus. The apparatus which has a predetermined function in usage restriction condition, comprises

a first obtaining section to obtain a first release information;

a second obtaining section to obtain a second release information;

an inverse-transformation section to process the second release information by using a inverse-transformation inverse to a predetermined transformation so as to generate a third release information;

a comparison section which compare the third release information with the first release information; and

a release section to release the predetermined function in usage restriction condition in case the third release information matches the first release information.

According to another aspect of the present invention, the information processing apparatus which has a first function and a second function in usage restriction condition, comprises

a first obtaining section to obtain a first release information;

a second obtaining section to obtain a second release information;

a designation section to designate a function to be released;

an inverse-transformation section to process the second release information by using a first inverse-transformation inverse to a first transformation when the first function is designated at the designation section, to process the second release information by using a second inverse-transformation inverse to a second transformation when the second function is designated at the designation section, and to generate a third release information by the inverse-transformation;

a comparison section which compare the third release information with the first release information; and

a release section to release the designated function in usage restriction condition in case the third release information matches the first release information.

According to another aspect of the present invention, the information processing apparatus which has a first function and a second function in usage restriction condition, comprises

a first obtaining section to obtain a first release information;

a second obtaining section to obtain a second release information;

an inverse-transformation section to process the second release information by using a first inverse-transformation inverse to a first transformation or a second inverse-transformation inverse to a second transformation, and to generate a third release information by the inverse-transformation;

a comparison section which compare the third release information with the first release information; and

a release section to release the first function in usage restriction condition in case the third release information obtained by the first inverse-transformation matches the first release information, and to release the second function in usage restriction condition in case the third release information obtained by the second inverse-transformation matches the first release information.

According to another aspect of the present invention, the information processing apparatus which has a first function and a second function in usage restriction condition, comprises

a first obtaining section to obtain a first release information generated from an original information by a first transformation or a second transformation;

a second obtaining section to obtain a second release information generated from the original information by a third transformation or a fourth transformation;

a designation section to designate a function to be released;

an inverse-transformation section to process the first release information by using a first inverse-transformation inverse to the first transformation and the second release information by using a third inverse-transformation inverse to the third transformation when the first function is designated at the designation section, to process the first release information by using a second inverse-transformation inverse to a second transformation and the second release information by using a fourth inverse-transformation inverse to the fourth transformation when the second function is designated at the designation section, and to generate a third release information and a fourth release information by the inverse-transformation;

a comparison section which compare the third release information with the fourth release information; and

a release section to release the designated function in usage restriction condition in case the third release information matches the fourth release information.

According to another aspect of the present invention, the information processing apparatus which has a first function and a second function in usage restriction condition, comprises

a first obtaining section to obtain a first release information generated from an original information by a first transformation or a second transformation;

a second obtaining section to obtain a second release information generated from the original information by a third transformation or a fourth transformation;

an inverse-transformation section to process the first release information by using a first inverse-transformation inverse to the first transformation or a second inverse-transformation inverse to a second transformation, to process the second release information by using a third inverse-transformation inverse to the third transformation or a fourth inverse-transformation inverse to the fourth transformation, and to generate a third release information and a fourth release information by the inverse-transformation;

a comparison section which compare the third release information with the fourth release information; and

a release section to release the first function in usage restriction condition in case the third release information obtained by the first inverse-transformation matches the fourth release information obtained by the third inverse-transformation, and to release the second function in usage restriction condition in case the third release information obtained by the second inverse-transformation matches the fourth release information obtained by the fourth inverse-transformation.

According to another aspect of the present invention, the information processing apparatus which has a predetermined function in usage restriction condition, comprises

a first obtaining section to obtain a first release information;

a second obtaining section to obtain a second release information;

a transformation section to process the first release information by using a predetermined transformation so as to generate a third release information;

a comparison section which compare the third release information with the second release information; and

a release section to release the predetermined function in usage restriction condition in case the third release information matches the second release information.

The invention itself, together with further objects and attendant advantages, will best be understood by reference to the following detailed description taken in conjunction with the accompanying drawings.

### BRIEF DESCRIPTION OF THE DRAWINGS

FIG. 1 is a diagram representing the schematic arrangement of the image processing apparatus of the present invention;

FIG. 2 is a diagram giving a conceptual representation of the approximate procedure for releasing the usage restriction on optional functions;

FIG. 3 is an explanatory diagram representing the overview of the method for separately releasing the usage restriction on the optional functions;

FIG. 4 is a block diagram representing the electrical arrangement of the devices for releasing the usage restriction;

FIG. 5 is a first explanatory diagram giving a specific example of generating release information and releasing the usage restriction on the optional functions according to the generated release information;

FIG. 6 is a second explanatory diagram giving a specific example of the process of releasing the usage restriction;

FIG. 7 is an explanatory diagram conceptually showing the steps ranging from production of a chip storing the release information, to shipment;

FIG. 8 is a flow chart showing the flow of the operation of designating the object to be released and releasing the usage restriction;

FIG. 9 is a flow chart showing the flow of the operation of automatically designating the object to be released and releasing the usage restriction;

FIG. 10 is a block diagram representing the electrical arrangement of the devices for releasing usage restriction in a third embodiment;

FIG. 11 is an explanatory diagram conceptually showing various steps in the third embodiment wherein a chip storing the release information is finally shipped; and

FIG. 12 is a flow chart showing the flow of the operation of designating the object to be released and releasing the usage restriction in the third embodiment.

In the following description, like parts are designated by like reference numbers throughout the several drawings.

### DESCRIPTION OF THE PREFERRED EMBODIMENT

Referring to the diagram, the following describes the embodiments of the present invention. The image processing apparatus will be described as an example of the information processing apparatus incorporating a predetermined function under usage restriction.

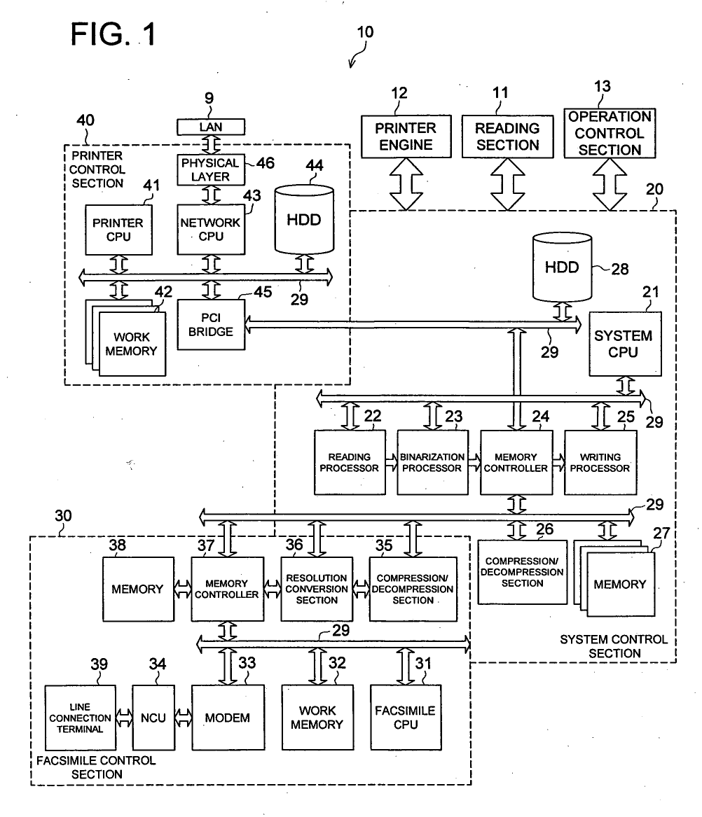

FIG. 1 shows the schematic arrangement of an image processing apparatus as an embodiment 10 of the present invention. The image processing apparatus 10 is formed as a so-called multi functional apparatus equipped with a plurality of function including a copying function for reading a document and forming a copied image on the recording paper, a facsimile function for sending and receiving the image data via the public line, and a printer function for printing an image based on the print data. In the initial phase, only the copying function of these functions is enabled. The facsimile function and printer function (hereinafter referred to as “optional function(s)”) are placed under usage restriction

The image processing apparatus 10 is provided with a system control section 20 for administrative control of the overall apparatus and copying function control; a facsimile control section 30 for facsimile function control; and a printer control section 40 for printer function control. The system control section 20 is connected with the reading section 11 for reading a document, the printer engine 12 for forming an image on the recording paper and outputting the same, and the operation control section 13 for receiving operation input from the user.

The reading section 11 is designed as a scanner containing a light source for irradiation of a document; a line image sensor for reading the document one line along the width; a moving section for moving the per-line reading position along the length of the document; and an optical path made up of a lens and mirrors for leading the light reflected from the document to the line image sensor so as to form an image. A CCD (charge coupled device), for example, is used as the line image sensor. The printer engine 12 is designed as a laser printer incorporating a recording paper conveyance apparatus, a photoreceptor drum, a charger, a laser unit, development apparatus, a transfer/separation device, a cleaning device, and a fixing device.

The operation control section 13 is made of a liquid crystal display equipped with a touch panel on the surface, and various types of operation switches. It serves the functions of displaying various forms of guide information and operation statuses and receiving the operation input by the user.

The system control section 20 is provided with a system CPU (Central Processing Unit) 21, a reading processor 22, a binarization processor 23, a memory controller 24, a writing processor 25, a compression/decompression section 26, a memory 27, and a HDD (Hard Disc Drive) 28. They are connected via a plurality of buses 29. The system CPU 21 operates in response to the program stored in the ROM (Read On Memory) and RAM (Random Access Memory).

The reading processor 22 applies processing of shading correction and enlargement and processing of analog-to-digital conversion to the analog image signal outputted from the line image sensor of the reading section 11, and outputs the multi-gradation digital image data. The binarization processor 23 applies processing of error diffusion thereto, and outputs the binary image data wherein each pixel is represented by either black or white. The compression/decompression section 26 compresses or decompresses image data. The memory 27 stores the compressed image data. The HDD 28 is a mass storage system for storing compressed image data and others. The memory controller 24 controls the compression and decompression by the compression/decompression section 26, and the operation of writing and reading the image data using the memory 27 and HDD 28. The writing processor 25 sends image data to the printer engine 12 sequentially.

The facsimile control section 30 is provided with a facsimile CPU 31, a work memory 32, a modem 33, NCU (Network Control Unit) 34, compression/decompression section 35, resolution conversion section 36, a memory controller 37 and a memory 38. The facsimile CPU 31 provides administrative control of the facsimile function. The work memory 32 temporarily stores various forms of data when the program is executed by the facsimile CPU 31. The telephone line and external telephone set via the line connection terminal 39. The NCU 34 is a circuit to control connection with the telephone network. It detects the reversing of the polarity of the telephone line and detects the ringing signal, and switches the connection of the telephone line over to the facsimile apparatus and external telephone.

The modem 33 is a modulator-demodulator for converting digital data to audio signals, or the audio signals to digital data. The modem 33 is installed between the NCU 34 and the bus 29 connected with each device of the facsimile control section 30. It converts data into the format that can be handled by each device and outputs it.

The resolution conversion section 36 changes the image size and resolution in response to the capacity of the remote system. The compression/decompression section 35 encodes and decodes image data by a predetermined method. The memory 38 stores the image data. The memory controller 37 controls the image data writing and reading operations using the memory.

The printer control section 40 is provided with a printer CPU 41, work memory 42, network CPU 43, HDD 44, and PCI (Peripheral Component Interconnect) bridge 45. The printer CPU 41 provides administrative control of the operation related to printer function. The work memory 42 temporarily stores various forms of data when the printer CPU 41 executes the program. The network CPU 43 provides administrative control of the operation of receiving the printing data from the external terminal (not illustrated) connected to the network, and others. The external terminal is connected to the network CPU 43 via the physical layer 46 such as the LAN (Local Area Network) and RS-232C (Recommended Standard 232 version C). The HDD 44 is a mass storage apparatus for storing the printing data having been received. The PCI bridge 45 is a relay for connecting between the buses 29 of the system control section 20 and printer control section 40.

When the optional function is placed under usage restriction, the operations of the facsimile CPU 31, printer CPU 41 and network CPU 43 are disabled by the system CPU, so that the devices of the facsimile control section 30 and printer control section 40 cannot be operated even if external data has been received. Further, the touch panel of the operation control section 13 does not display the operation buttons of the function. The operation instruction from the user cannot be accepted.

The following describes the procedure of releasing the usage restriction of the facsimile function and printer function:

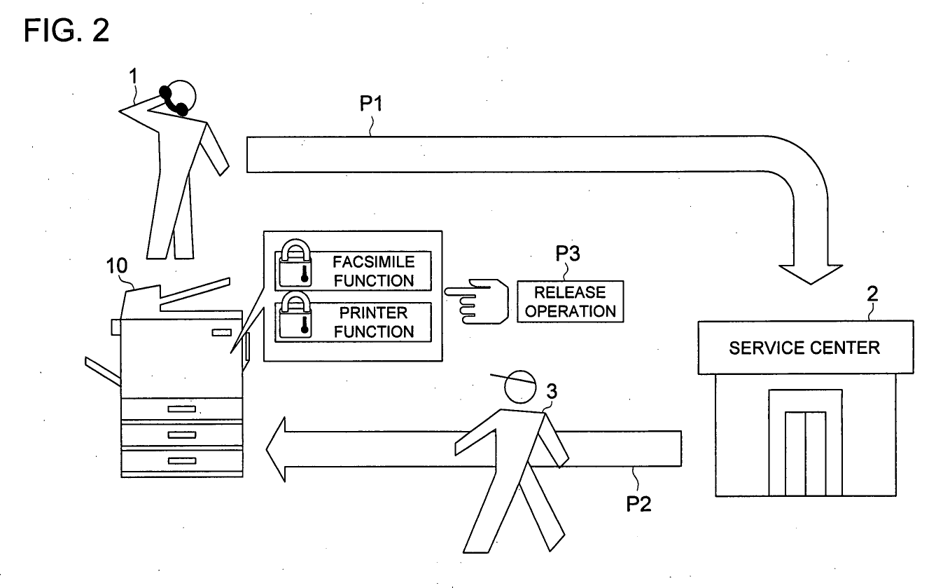

FIG. 2 gives a conceptual representation of the overall procedure for releasing the usage restriction of the optional function. When wishing to use the optional function, the user 1 contacts the service center 2 to make an additional purchase of a required function (P1). When the optional function has been obtained, service personnel 3 is dispatched from the service center 2 (P2). The service personnel 3 releases the usage restriction of the optional function separately (P3).

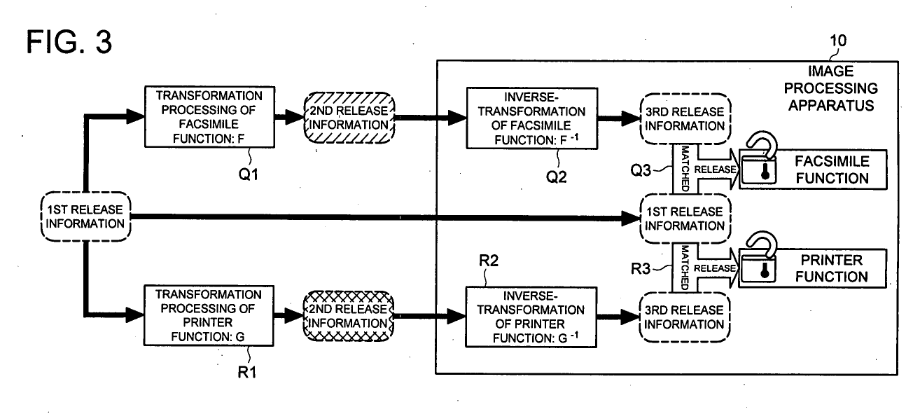

FIG. 3 outlines the technique of releasing the usage restriction of the optional function separately.

The release of the usage restriction is started by obtaining the first release information and second release information. In the image processing apparatus 10, two pieces of release information having been obtained are checked to see whether or not they have transformation/inverse transformation correspondence. Based on the result of this check, a decision step is taken to determine if usage restriction can be released or not.

Of the two pieces of release information, the first release information uses arbitrary information. The second release information is generated by applying transformation processing conforming to the function (object to be released) of releasing the usage restriction, to the first release information. For example, if transformation processing “F” for facsimile function is applied to the first release information (Q1), the second release information for facsimile function is generated. If transformation processing “G” for printer function is applied to the same first release information (R1), the second release information for printer function is generated. Transformation processing transforms a certain piece of information to another piece of information corresponding thereto according to a predetermined rule. When transformation processing has been applied to the first release information to generated the second release information, these pieces of information are provided with transformation/inverse transformation correspondence.

In the image processing apparatus 10, on the other hand, inverse transformation of the aforementioned transformation processing is applied to the second release information having been obtained. For example, when one wishes to release the usage restriction of the facsimile function, the inverse transformation “F⁻¹” of the transformation processing “F” for facsimile function is applied to the second release information for facsimile function Q2). To release the usage restriction of the printer function, inverse transformation “G⁻¹” of the transformation processing “G” for the printer function is applied to the second release information for printer function (R2).

Inverse transformation ensures that the information having been obtained by transformation processing is put back to the original information. Thus, when the third release information obtained by application of the inverse transformation to the second release information matches the first release information, a transformation/inverse transformation correspondence can be confirmed to be present between the two pieces of release information having been obtained. For example, if information management is carried out to ensure that the release information is accessible only to the service personnel or other authorized personnel, a decision step can be taken to determine if the operation to release the usage restriction is legal or not, by checking if inputted release information having been inputted has this correspondence or not.

The optional function as an object to be released can be identified, depending on whether the inverse transformation for facsimile function or printer function was used to check the transformation/inverse transformation correspondence. Based on this way of thinking, image processing apparatus 10 allows the usage restriction of facsimile function to be released, when the third release information obtained by inverse transformation “F⁻¹” applied to the second release information for facsimile function has matched the first release information (Q3). It allows the usage restriction of printer function to be released, when the third release information obtained by inverse transformation “G⁻¹” applied to the second release information for printer function has matched the first release information (R3).

Based on the technique introduced so far, the following describes the details of the image processing apparatus 10 wherein usage restrictions imposed on the facsimile function and printer function are separately released:

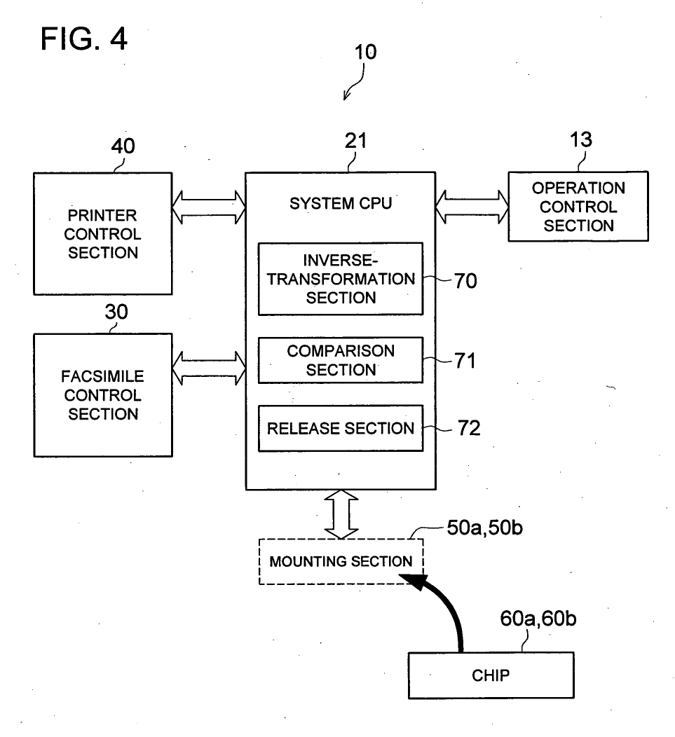

FIG. 4 represents the electrical arrangement of the devices for releasing the usage restriction in the image processing apparatus 10.

The system CPU 21 provides administrative control of the operation to release the usage restriction. The operation control section 13 serves a function as a designation section which receives the designation given by the service personnel via the touch panel, specifying the function as an object to be released. It also serves the function of the second obtaining section that obtains the second release information. The printer control section 40 and facsimile control section 30 serve the function of releasing the usage restriction.

The system CPU 21 is connected with the mounting sections 50a and 50b. The mounting sections 50a and 50b serve the function of the first obtaining section for obtaining the first release information from the chip 60a for facsimile function and the chip 60b for printer function. The mounting sections 50a and 50b are arranged as inlets of the chips 60a and 60b. They are provided on the substrate inside the image processing apparatus 10.

The chip 60a for facsimile function and the chip 60b for printer function are the semiconductor devices having a storage function. The chips 60a and 60b serve as the first storage media for storing the first release information for optional function. In the present embodiment, a compact one-chip microcomputer (hereinafter referred to as “chip 60”) that does not occupy a large space is adopted. The chip 60 is a compact integrated circuit formed of a CPU (not illustrated), a memory and interface. In the present embodiment, the memory-related functions are utilized.

The system CPU 21 also serves as an inverse transformation section 70, comparison section 71 and release section 72. The inverse transformation section 70 applies inverse transformation conforming the designated function to the second release information. The comparison section 71 compares the first release information with the third release information obtained by inverse transformation of the second release information, and supplies the result of comparison to the release section 72. The release section 72 releases the usage restriction of the designated function if there is a match between the first release information and the third release information.

If the usage restriction has been released, the usage restrictions on the facsimile CPU 31 and printer CPU 41 by system CPU 21 are released. The operation buttons for the optional function are displayed on the touch panel of the operation control section 13. This allows the optional function to be utilized.

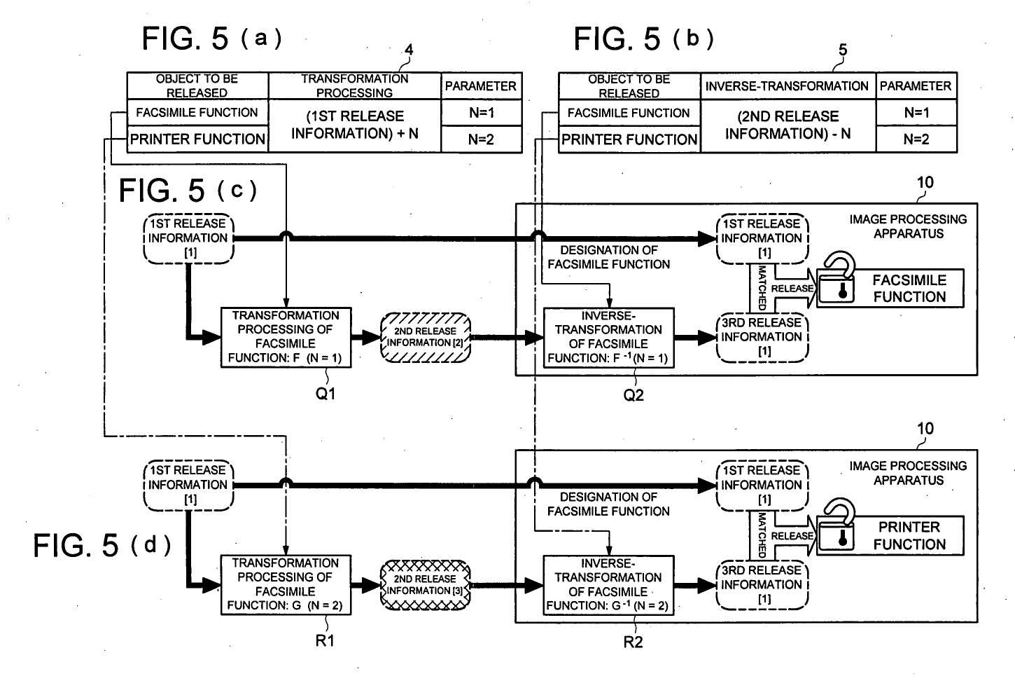

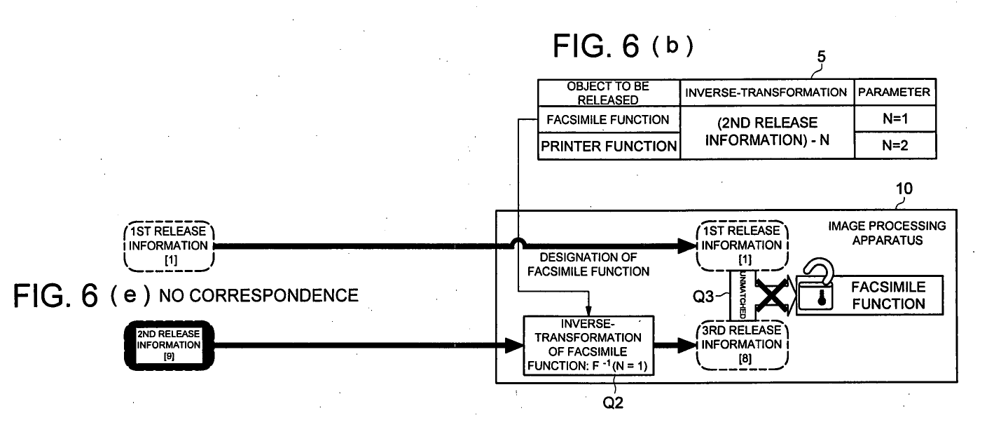

FIGS. 5 and 6 show specific examples of generating the release information and releasing the usage restriction of the optional function. For simplifying the explanation, the following describes the case where the release information is one-digit digital information, which is subjected to simple inverse transformation.

FIG. 5 (a) gives an example of the Transformation Table 4 representing the rule of transformation processing for generating the second release information from the first release information. According to the Transformation Table 4, the second release information is generated when the transformation of “(the first release information)+N” is applied to the first release information, where “N” denotes a parameter to be set in response to the object to be released.

When the second release information for facsimile function is generated, the parameter “N=1” is set and the transformation processing “F” of “(the first release information)+1” is applied. When the second release information for printer function is generated, the parameter “N=2” is set and the transformation processing “G” of “(the first release information)+2” (N=2) is applied.

FIG. 5 (b) shows an example of the Inverse Transformation Table 5 representing the rule of inverse transformation applied to the second release information in the image processing apparatus 10. The Inverse Transformation Table 5 allows the third release information to be generated when the inverse transformation of “(second release information)−N” is applied to the Inverse Transformation Table 5. This inverse transformation ensures that the second release information having been generated by the transformation processing based on the Transformation 4 is put back to the original first release information.

When the facsimile function has been designated as an object to be released, the parameter “N=1” is set and the inverse transformation “F⁻¹” of “(second release information)−1” is applied.

When the printer function has been designated as an object to be released, inverse transformation “G⁻¹”, of “(second release information)−2” (N=2) is applied.

FIG. 5 (c) shows an example of generating the third release information for facsimile function, obtaining the same and releasing the usage restriction on the facsimile function.

When the transformation processing “F” for facsimile function is applied to the first release information “1” (Q1), the second release information “2” formed by adding “1” added to the first release information is generated. When the image processing apparatus 10 obtains the first and second release information, and the facsimile function is designated as the object to be released, then inverse transformation “F⁻¹” for facsimile function is applied to the second release information (Q2). This procedure provides the third release information “1” which is obtained by subtracting “1” from the second release information “2”. This matches the first release information, and therefore, the usage restriction on the facsimile function having been designated is released (Q3).

As described in FIG. 5 (d), when transformation processing for printer function “G” is applied to the same first release information “1” (R1), the second release information “3” obtained by adding 2 to the first release information is generated. When the image processing apparatus 10 has acquired release information and the printer function is designated, the inverse transformation for printer function “G⁻¹” is applied to the second release information (R2). This will provide the third release information “1” which is obtained by subtracting 2 from the second release information “3”. This matches the first release information, and therefore, the usage restriction on the printer function having been designated is released (R3).

FIG. 6 (e) shows the processing wherein the first release information “1”, and second release information “9” have been obtained, and the facsimile function has been designated as the object to be released. Between the second release information “9” and the first release information, there is no a transformation/inverse transformation correspondence based on the transformation processing “G” for facsimile function. Even when the inverse transformation for facsimile function “F⁻¹” is applied to the second release information “9” (Q2), the digital information “8” as the third release information having been obtained fails to match the first release information. This does not release the usage restriction on facsimile function.

Even if the transformation processing and inverse transformation, and release information are made more complicated, the same principle is employed to separately release the usage restrictions on the facsimile function and printer function, based on the transformation/inverse transformation correspondence between the first release information and second release information. The following describes the case where transformation processing and release information are more complicated, and means are provided to prevent the transformation/inverse transformation correspondence from illegally identified.

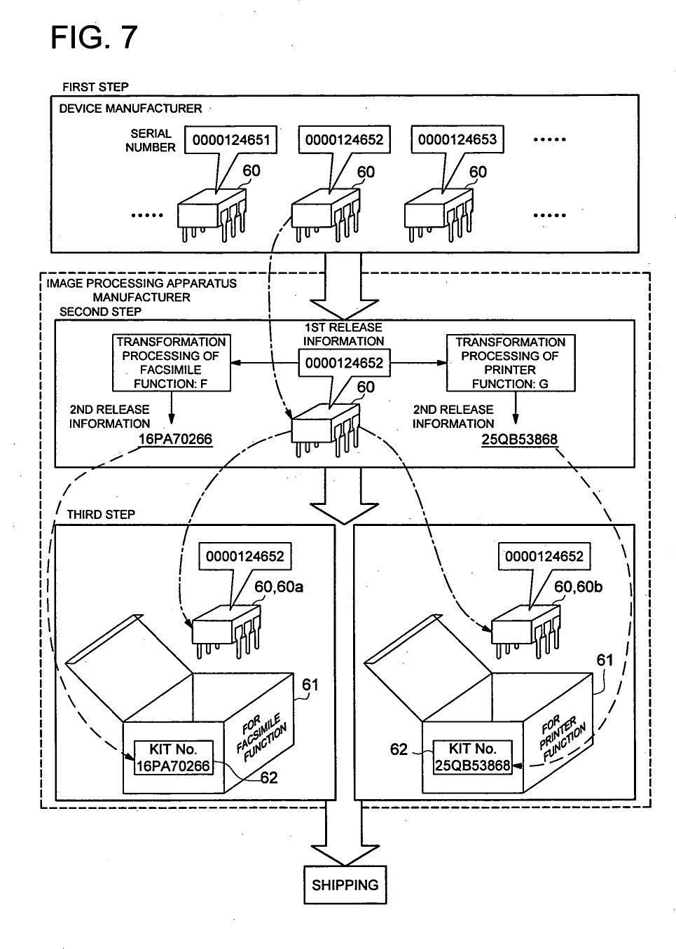

FIG. 7 schematically shows the steps ranging from the production of the chip 60 storing the first release information to the shipment thereof.

The process leading to the shipment of a chip 60 includes a first step of producing a chip 60, a second step of generating the first release information, and a third step of packaging the chip 60 storing the first release information. The first step is taken by the device manufacturer of the chip 60, and the second and third steps are taken at an implementation factory of the image processing apparatus manufacturer.

FIG. 7 showing the first step schematically illustrates the chip 60 production step. In the first step, each chip 60 is inscribed with a serial number at the time of producing the chip 60. The serial number is the proper identification information generated according to a predetermined rule, and is capable of identify each chip 60 uniquely. In this example, a sequence of 10-digit numbers are arranged incrementally in the order of production of the chips 60. Writing the proper identification information at the time of production eliminates the need for the image processing apparatus manufacturer to separately generate and write the proper identification information.

FIG. 7 showing the second step schematically represents the step of generating the second release information from the serial number (the first release information). In the second step, a serial number is read from the chip 60 purchased from the device manufacturer and transformation processing conforming to the optional function is applied.

When predetermined transformation processing is applied to the serial number as the first release information, a string of characters having a transformation/inverse transformation correspondence with the first release information is generated. The string of characters having been generated is used as the second release information. In this case, if transformation processing “F” for facsimile function is applied to the first release information, second release information for facsimile function is generated. If transformation processing “G” for printer function is applied, the second release information for printer function is generated. As described above, in the second step, the release information conforming to the optional function can bed generated merely by modifying the contents of transformation processing, without any modification made to the information stored in the chip 60,

FIG. 7 showing the third step schematically represents the step of packaging the chip 60 storing the release information. In the third step, the chip 60 storing the first release information is packed in the packaging case 61. The second release information having a transformation/inverse transformation correspondence with this first release information is recorded on the recording paper 62. In this case, the recording paper serves as a second recording medium for storing the second release information. The recording paper 62 for storing the second release information is packed together in the packaging case 61 containing the chip 60, and is shipped to the service center 2 or a similar place. If the second release information for facsimile function is recorded on the recording paper 62, it is shipped as a chip 60a for facsimile function. If the second release information for printer function is recorded, it is shipped as a chip 60b for printer function.

In the illustrated example, the recording paper 62 having recorded the second release information under “Kit number” is attached on the side of the packaging case 61. Thus, handling is facilitated at the time of storage and transportation, by ensuring that two pieces of release information having transformation/inverse transformation correspondence are not separated from each other. If the “Kit number” is assigned with the symbol from which the role of the information cannot be easily identified, the relationship with the first release information stored in the chip 60 cannot be easily identified by a third party.

The way of packaging the chip 60 and the recording medium for recording the second release information together in one packing case is not restricted to the method described above. For example, the recording paper 62 can be packed in the packaging case 6, or the second release information can be directly printed on the outside of the chip 60, instead of the recording paper 62. Alternatively, the second release information can be recorded on the recording medium such as a semiconductor memory and CD (Compact Disk).

When this chip 60 is mounted on the image processing apparatus 10, the first release information is obtained. Further, based on the recording paper 62 packed in the packaging case 61 together, the second release information is obtained by the service personnel or others.

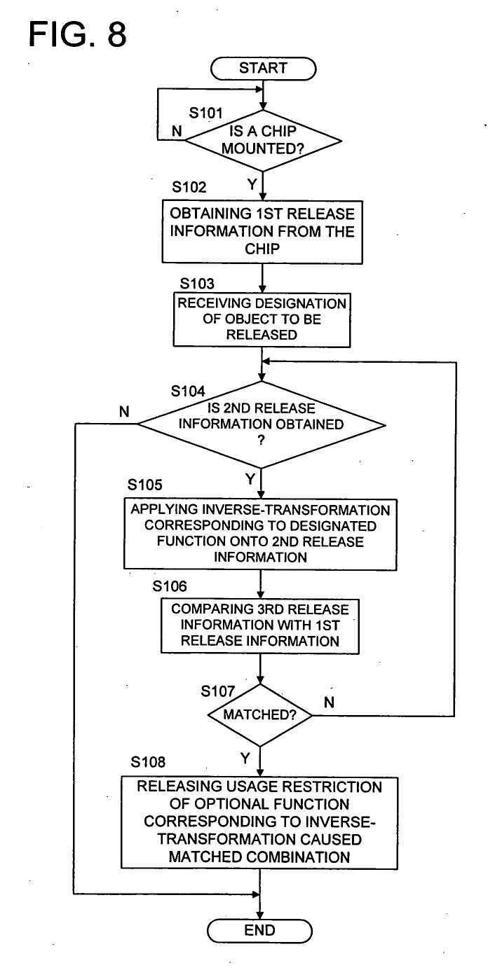

FIG. 8 shows the flow of the operation of designating the object to be released and releasing the usage restriction.

The image processing apparatus 10 waits until the chip 60 is mounted thereon (N in Step S101). When the chip 60 has been mounted (Y in Step S101), it obtains the first release information therefrom (Step S102). In response to the designation of the object to be released (Step S103), verification is made to see if the second release information has been obtained or not (Step S104). If the second release information cannot be obtained within a predetermined time, or designation of cancellation has been received (N in Step S104), the operation terminates immediately (End).

If the second release information obtained (Y in Step S104), inverse transformation in response to the designated function is applied to the second release information (Step S105). After that, the first release information is compared with the third release information obtained by application of the inverse transformation to the second release information (Step S106). If they fails to match each other (N in Step S107), the system goes back to the step of checking if another (still unchecked) second release information has been obtained or not (Step S104).

If they have matched each other (Y in Step S107), usage restriction on the designated optional function is released (Step S108) and the operation terminates (End).

In the image processing apparatus 10 of the present embodiment, verification is made to see if two pieces of release information having been obtained has a transformation/inverse transformation correspondence with each other or not. A decision step is taken to check if the usage restriction on the designated optional function can be released or not. For this purpose, transformation processing to establish this correspondence and the details of the inverse transformation for verifying the presence/absence of this correspondence are kept confidential. This arrangement avoids the risk of the usage restrictions being released by the illegally generated release information. Unlike the release by password input, the reference password is not stored in the image processing apparatus 10 in advance. This eliminates the need for the image processing apparatus manufacturer to manage the input password corresponding thereto. This ensures simplified release information. Further, required pieces of release information can be generated as required. This eliminates the need to generate the release information in advance. This further reduces the time and labor for release information management.

In the image processing apparatus 10, separate release of usage restrictions on two optional functions can be achieved by check if the two pieces of release information having been obtained has a transformation/inverse transformation correspondence conforming to the designated optional function or not. This arrangement permits separate sales of two optional functions, and broadens the scope of user choice, thereby improving convenience.

When attention is paid to the process of generating the release information, different second release information conforming to each optional function can be generated merely by modifying the contents of transformation processing, even from the same first release information.

Further, if the first release information is stored in the chip 60, the chip 60 can be used as a physical key. For example, even if two pieces of release information have leaked, the usage restriction cannot be released if the chip 60 conforming to each image processing apparatus 10 cannot be obtained. This arrangement provides improved security against illegal release. The physical key can be sealed in the packaging case 61 or kept in a warehouse. This improves the security of the first release information stored inside. This arrangement also ensures improved security in the sense that illegal acquisition of release information is more difficult.

Usage restrictions on two optional functions can be released separately by modifying the inverse transformation. This arrangement eliminates the need of using different chip 60 for each object to be released, or modifying the method of installing the chip 60 (installation position). This makes it possible to standardize the chips 60, with the result that the cost is reduced. Since there is no need of identifying the chip 60 for every object to be released, management after the purchase is facilitated. This arrangement also makes it possible to standardize the method of installing the chip 60, and therefore, the risk of apparatus damage due to operation error can be avoided.

Further, each serial number of the chip-60 adopted to provide the first release information containing different information. There is only one piece of second release information that has a predetermined transformation/inverse transformation correspondence with certain first release information. Despite the illegal acquisition of a plurality of chips 60, usage restrictions cannot be released, so long as the second release information having a transformation/inverse transformation correspondence with the first release information is not acquired. Thus, this arrangement improves the security against illegal release, as compared with the case wherein the common first release information is used in all the information processing apparatuses.

The following describes the second embodiment wherein the object to be released is automatically selected if release information has been obtained, instead of designating the object to be released.

The schematic arrangement of the image processing apparatus 10 as the second embodiment is the same as the one shown in FIG. 1. The electrical arrangement of the devices related to the usage restriction releasing function is the same as the one shown in FIG. 4; provided, however, that the functions of the following portion are different from those of the first embodiment: The inverse transformation section 70 applies two inverse transformations corresponding to the facsimile function and printer function separately to the second release information. In the first embodiment, only the inverse transformation conforming to the designated object to be released applied. In the second embodiment, however, all the available inverse transformations are applied to the second release information, without receiving designation of the function as the object to be released, thereby generating the same number of pieces of the third release information as that of inverse transformations having been applied. This is the difference from the first embodiment.

The comparison section 71 compares the first release information with the second release information having been subjected to two inverse transformations separately, and supplies the result thereof to the release section 72. In the first embodiment, the third release information obtained by application of only the inverse transformation corresponding to the designated object to be released was compared with the first release information. In the second embodiment, all the available inverse transformations are applied to the second release information, without receiving designation of the function as the object to be released. Thus, the same number of pieces of the third release information as that of inverse transformations having been applied is compared with the first release information. This is the difference from the first embodiment.

If the first release information matches the third release information having been obtained by application of the inverse transformation for facsimile function as a result of comparison by the comparison section 71, the release section 72 releases the usage restriction on the facsimile function. It matches the third release information having been obtained by application of the inverse transformation for printer function, the release section 72 releases the usage restriction on the printer function. In the first embodiment, a decision step is taken to determine if the usage restriction of only the designated object to be released can be released or not. This is where the second embodiment is different from the first.

In the second embodiment, designation of the function as the object to be released is not received. The operation control section 13 has no function as a designation section for receiving the designation of the function as the object to be released. The chip 60 storing the release information is manufactured in the same step as in FIG. 7.

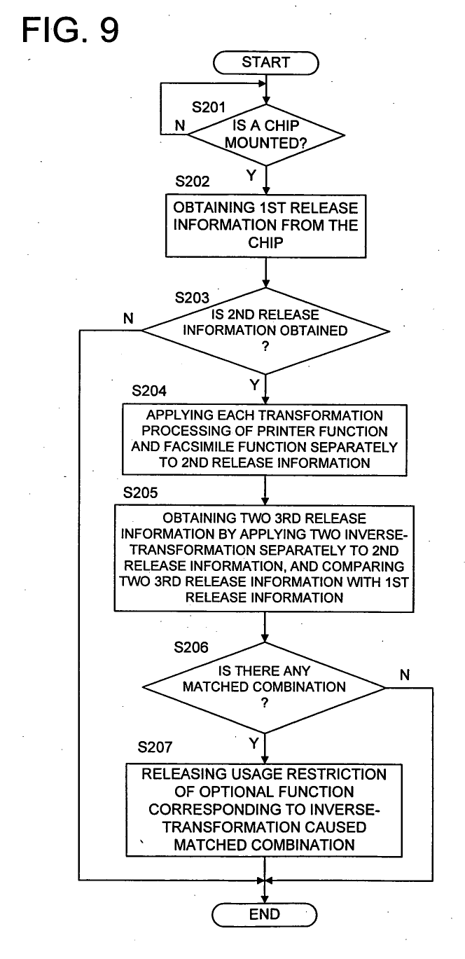

FIG. 9 shows the flow of the operation of automatic selection of the object to be released, and release of the usage restriction.

The operations (in Steps S201 through S202) ranging from the mounted chip 60 to the acquisition of the first release information are the same as those in the first embodiment (Steps S101 through S102), and will not be described to avoid duplication. After the first release information has been obtained, the image processing apparatus 10 checks if the second release information obtained or not (Step S203). If the second release information has not been obtained (N in Step S203), the operation terminates immediately (End).

When the second release information has been obtained (Y in Step S203), two inverse transformations for facsimile function and printer function are applied separately to the second release information (Step S204). Two pieces of third release information obtained by separate application of two inverse transformations to the second release information are compared with the first release information (Step S205).

If there is no combination wherein the first release information matches the third release information (N in Step S206), the operation terminates immediately (End). If there is such a combination (Y in Step S206), the usage restriction on the optional function corresponding to the inverse transformation giving the result of matching is released (Step S207), and the operation terminates (End).

In the image processing apparatus 10 as the second embodiment, the inverse transformation corresponding to each optional function is tried. In response to the result thereof, the object to be released is automatically selected. This arrangement eliminates the need of designating the object to be released. This eliminates the possible operation error of designating the object that cannot be released by the release information having been inputted. Thus, the maneuverability is improved.

In the first and second embodiments, a decision step is taken to check whether or not the first release information matches the third release information obtained by application of the inverse transformation of a predetermined transformation to the second release information. If they match with each other, usage restriction on the function is released. This is because a decision step is taken to determine that the obtained second release information has been obtained by application of a predetermined transformation to the first release information; i.e., the second release information has been obtained legally. Viewed in this light, it is also possible to make the following arrangements, without being restricted to the aforementioned case: Namely, a decision is made to check whether or not the second release information matches the third release information having been obtained by application of the predetermined transformation to the first release information. If they match each other, the restriction on the function is released. In this case, the second release information having been obtained is the information gained by application of a predetermined transformation to the first release information. In other words, a decision step has been taken to conclude that this information has been obtained legally.

The following describes the third embodiment wherein one of the two pieces of release information is stored in the image processing apparatus in advance: The schematic arrangement of the image processing apparatus as the third embodiment is the same as that shown in FIG. 1.

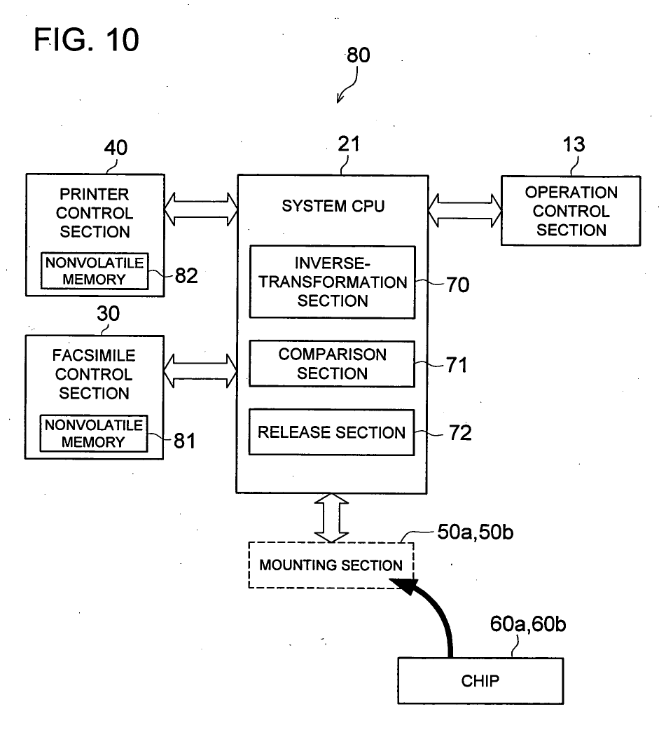

FIG. 10 shows an electrical arrangement of the device related to the usage restriction releasing function of the image processing apparatus 80 as the third embodiment. Similarly to the image processing apparatus 10 shown in the first embodiment, the image processing apparatus 80 has the facsimile function and printer function placed under usage restrictions. In the image processing apparatus 80, one of the pieces of release information is stored in the apparatus in advance, without two pieces of release information being obtained at the time of releasing the usage restriction. In this respect, the third embodiment is different from the first embodiment. In FIG. 10, the same portions as those shown in FIG. 4 are assigned with the same reference numerals.

The facsimile control section 30 and printer control section 40 each are provided with the nonvolatile memories 81 and 82. The nonvolatile memories 81 and 82 are rewritable devices capable of maintaining the stored data even if the power source is turned off. The nonvolatile memories 81 and 82 are made up of a semiconductor memory, HDD and others. The nonvolatile memories 81 and 82 serve as storage sections for storing in advance the first release information for releasing each of usage restrictions of facsimile function and printer function. The first release information can be stored in the form associated with each function in the ROM (not illustrated) and others, instead of the nonvolatile memories 81 and 82 of the controllers 30 and 40.

The mounting sections 50a and 50b serve as the second obtaining sections for obtaining the second release information from the mounted chips 60a and 60b. In the first embodiment, they serve as the first obtaining sections for obtaining the first release information. In this respect, the third embodiment is different from the first.

The inverse transformation section 70 applies the inverse transformation to the second release information having been obtained from the chip 60. In the first embodiment, inverse transformation is applied to the second release information having been obtained. In this respect, the third embodiment is different from the first. The comparison section 71 compares the first release information stored in advance in the nonvolatile memories 81 and 82, with the third release information obtained by application of inverse transformation to the second release information, and supplies the result of comparison to the release section 72. In the first embodiment, comparison is made based on the two pieces of release information having been obtained from the outside. In this respect, the third embodiment is different from the first.

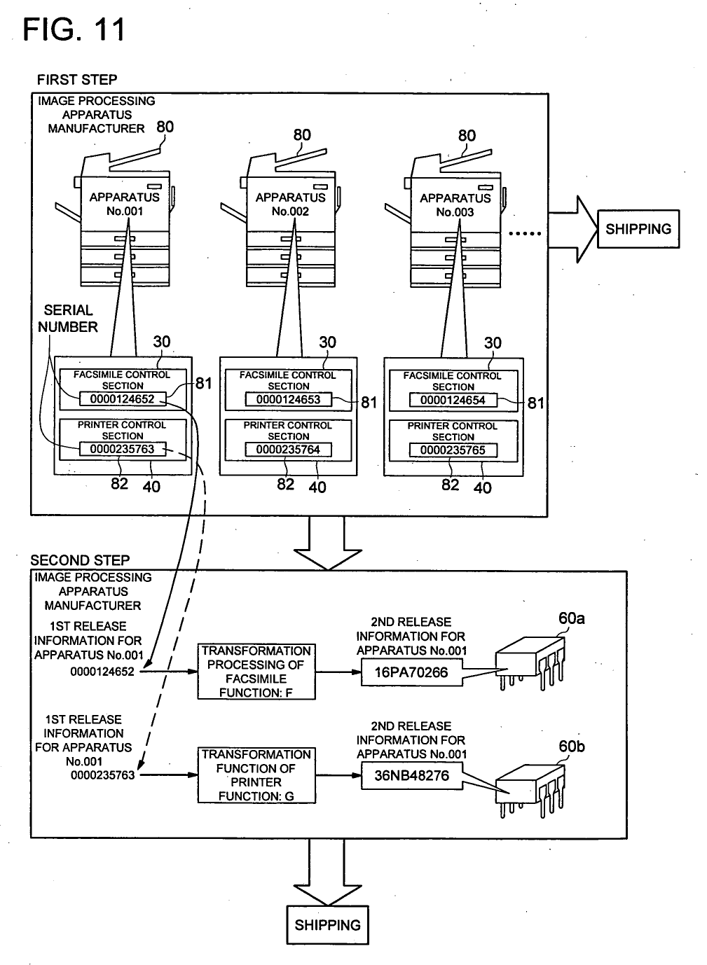

FIG. 11 schematically shows the various steps in the third embodiment wherein the chip 60 storing the second release information is shipped in the final step.

The steps wherein the chip 60 storing the release information is finally shipped includes the first step for storing the serial number for each object to be released, in image processing apparatus 80, and the second step for generating the release information from the serial number. These steps are executed in the implementation factory of the image processing apparatus manufacturer.

FIG. 11 schematically shows the first step of storing the serial number for each object to be released. In the first step, at the time of manufacturing the image processing apparatus 80, the serial numbers inherent to the facsimile control section 30 and printer control section 40 are written in the nonvolatile memories 81 and 82. The serial number is the proper identification information generated by a predetermined rule, and capable uniquely specifying each of the facsimile control section 30 and printer control section 40. In this example, the manufacturing number set at the time of manufacturing the mother board of the each controller is adopted as the serial number. The image processing apparatus 80 is provided with the facsimile control section 30 and printer control section 40 assigned with the serial numbers, and is shipped to each user.

FIG. 11 schematically shows the second step of generating the second release information from the serial number (the first release information) of each of the controllers 30 and 40. In the second step, transformation processing conforming to the optional function is applied to the serial number inherent to each of the facsimile control section 30 and printer control section 40. The method of applying to the serial number the transformation processing conforming to the object to be released has already been described with reference to FIG. 5, and will not be described again.

The serial number stored in the nonvolatile memories 81 and 82 of each controller is assumed as the first release information, and transformation processing conforming to the optional function is applied to this serial number. This procedure generates a string of characters having a transformation/inverse transformation correspondence with the first release information. The string of characters having been generated is written in the chip 60 as the second release information.

The first release information is already stored in a specified image processing apparatus 80. Thus, the chip 60 containing the second release information for facsimile function written thereon becomes the chip 60a for the facsimile function devoted solely for image processing apparatus 80 storing the original first release information. This description also applies to the chip 60b for printer function.

Through the aforementioned steps, the chips are shipped in order to release the usage restriction on the image processing apparatus 80 corresponding to the chip 60a for facsimile function and chip 60b for printer function.

The serial numbers of the facsimile control section 30 and printer control section 40 may be placed under separate management for the purpose of maintenance and parts replacement. In this case, the proper identification information already placed under separate management for other purposes is used as the first release information. This arrangement eliminates the need of independently generating the first release information and storing it in the image processing apparatus 80. This also eliminates the time and labor for independent generation of the first release information independently or a long-term storage of the first release information for the sole purpose of generating the second release information.

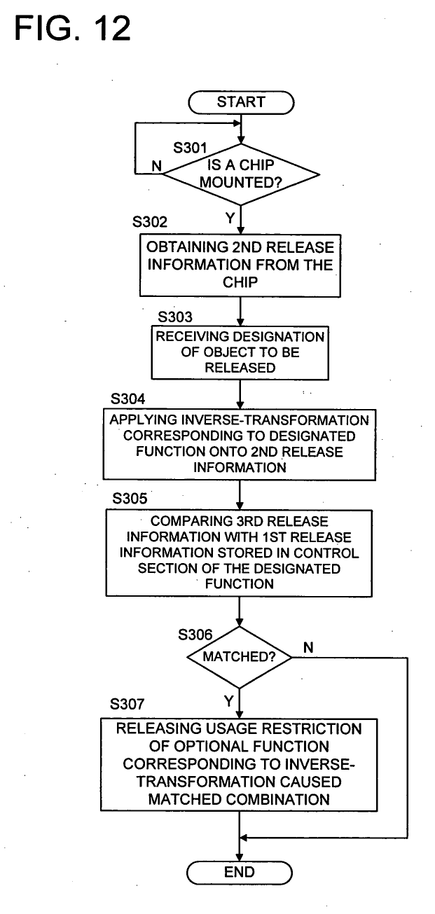

FIG. 12 shows the flow of the operation for releasing the usage restriction on a designated optional function in the third embodiment.

The image processing apparatus 80 waits for the chip 60 to be mounted thereon (N in Step S301). When the chip 60 is mounted (Y in Step S301), second release information is obtained therefrom (Step S302). In response to the designation of the function as an object to be released (Step S303), inverse transformation conforming to the designated function is applied to the second release information (Step S304).

After that, the first release information and second release information stored in the controller of the designated function is compared with the third release information obtained by application of inverse transformation (Step S305). If no match is found as a result of comparison (N in Step S306), the operation terminates immediately (End). If a match is found as a result of comparison (Y in Step S306), the usage restriction on the designated optional function is released (Step S307), and the operation terminates (End).

In the image processing apparatus 80 as the third embodiment, the usage restriction on the designated optional function can be released merely by obtaining the second release information corresponding to the first release information stored in advance. This arrangement ensures simplified operation for releasing the usage restriction.

The serial numbers inherent to the facsimile control section 30 and printer control section 40 of the image processing apparatus 80 are stored in advance as the first release information. Thus, the usage restriction can be released only when the unique second release information corresponding thereto is used. This arrangement avoids the risk of illegal release of the usage restrictions on a plurality of image processing apparatuses 80, using one chip 60 containing the second release information.

The embodiments of the present invention have been described with reference to diagrams. It is to be expressly understood, however, that the present invention is not restricted thereto. The present invention can be embodied in a great number of variations with appropriate modification or additions, without departing from the technological spirit and scope of the invention claimed.

The embodiments have been described with reference to the examples of image processing apparatuses 10 and 80. The present invention can also be applied to various apparatuses (information processing apparatuses) placed under usage restriction to disable a predetermined function at the time of shipment.

Further, the present invention is not restricted to the cases where the image processing apparatuses 10 and 80 have two optional functions, facsimile function and printer function. The present invention applies to the image processing apparatus having three or more optional functions.

In the aforementioned embodiments, usage restriction release operation is performed by the service personnel of an image processing apparatus manufacturer. The user is allowed to perform the release operation in person.

In the aforementioned embodiments, the inverse transformation is applied to one of the two pieces of release information. It is also possible to make such arrangements that inverse transformation is applied to either of two pieces of release information. For example, two mutually differing forms of transformation processing (the first transformation processing and second transformation processing) are separately applied to certain original information. The first release information corresponding to each of the facsimile function and printer function is generated. Two mutually differing forms of transformation processing (the third transformation processing and fourth transformation processing), different from the form of transformation processing used for the generation of the first release information, are separately applied to the same original information as used for the generation of the first release information. Thus, the second release information corresponding to each of the facsimile function and printer function is generated. These two pieces of release information are obtained by the image processing apparatus. The inverse transformation of the transformation processing conforming to the object to be released is applied to the first release information, whereby the third release information is obtained. Similarly, the inverse transformation of transformation processing conforming to the object to be released is applied to the second release information, wherein the fourth release information is obtained. If there is a match between the third release information and the fourth release information as a result, the usage restriction of the object to be released is released. Such an arrangement is also possible. In this case, designation of the object to be released may be accepted, or the object to be released may be automatically selected.

Alternatively, usage restriction on two optional functions may be released using one semiconductor device. For example, it is also possible to arrange such a configuration that the chip 60 stores two pieces of the first release information, and the second release information conforming to each of them is inputted, thereby releasing the usage restriction on facsimile function and printer function.

In the present invention, in particular, the different pieces of second release information corresponding to each of the optional functions can be generated from the same pieces of the first release information by changing the transformation processing applied to the first release information. It is also possible to arrange such a configuration that the usage restrictions on two functions can be released by mounting one semiconductor device containing one piece of the first release information and by inputting the two pieces of second release information having been generated by different forms of transformation processing.

Further, in the third embodiment where one of the two pieces of release information is stored in the image processing apparatus 80 in advance, it is also possible to make such arrangements that the object to be released is automatically selected.

The information processing apparatus and usage restriction release method according to the present invention determines whether usage restriction on the optional function can be released or not, by checking whether two pieces of release information having been obtained has a transformation/inverse transformation correspondence or not. If the transformation processing that causes this correspondence to occur and the details of inverse transformation for checking the presence/absence of the correspondence are kept confidential, it is possible to avoid the risk of the usage restriction being released by using the illegally generated release information. Unlike the release by password input, a reference password is not stored in the information processing apparatus in advance. Corresponding passwords to be inputted need not be managed by the information processing apparatus manufacturer and others, with the result that release information management is simplified. Further, only the required amount of the release information can be generated only when required. This eliminates the need of generating the release information in advance, and reduces the time and labor required for the management of release information.

According to the preferred embodiment of the present invention, transformation processing is a process of transforming a certain piece of information into another piece of information corresponding thereto according to a predetermined rule. The inverse transformation is a process of returning the information having been obtained by transformation processing, back to the original information. The information processing apparatus applies predetermined inverse transformation to the second release information, thereby checking to see if the second release information is generated from the first release information or not. It releases the usage restriction only when a transformation/inverse transformation correspondence has been confirmed between two pieces of release information demonstrating that the second release information is generated from the first release information.

As described above, the information processing apparatus determines whether usage restriction can be released or not, depending on whether two pieces of release information has a transformation/inverse transformation correspondence or not. If the transformation processing that causes this correspondence to occur and the details of the inverse transformation for checking the presence/absence of the correspondence are kept confidential, it is possible to avoid the risk of the usage restriction being released by using the illegally generated release information. Unlike the release by password input, a reference password is not stored in the information processing apparatus in advance. Corresponding passwords to be inputted need not be managed by the information processing apparatus manufacturer and others. Further, only the required amount of the release information can be generated only when required. This eliminates the need of generating the release information in advance, and reduces the time and labor required for the management of release information.

According to another aspect of the preferred embodiment of the present invention, in an information processing apparatus provided with two optional functions under usage restriction, if the first release information matches the third release information obtained from inverse transformation applied to the second release information in response to the designated function, the usage restriction of the designated optional function is released. The second release information is generated by applying different transformation processing to the first release information in response to the function of releasing the usage restriction, and therefore, the transformation/inverse transformation correspondence between two pieces of release information is different for each optional function. The usage restrictions of the two optional functions can be separately released by checking whether or not the two pieces of release information having been obtained has the transformation/inverse transformation correspondence in response to the designated optional function. This arrangement permits separate marketing of two optional functions, and provides extensive ranges of user choice to ensure greater convenience.

When attention is paid to the process of generating the release information, different second release information conforming to each optional function can be produced even from the same first release information merely by changing the contents of transformation processing.

Even if the number of the optional functions is three or more, both the first and second functions can be regarded as being incorporated, when attention is paid to two optional functions selected therefrom. Thus, this Structure can be applied to the information processing apparatus provided with three or more optional functions, thereby providing separate release of the usage restriction of each function.

According to another aspect of the preferred embodiment of the present invention, in an information processing apparatus provided with two optional functions under usage restriction, the third release information obtained by applying two pieces of inverse transformation in response to the optional function separately to the second release information is compared with the first release information. When the first release information matches the third release information, the usage restriction of the optional function corresponding to the inverse transformation obtained from the result of matching is released. Inverse transformation corresponding to each optional function is tried. In response to the result thereof, the system automatically selects the function whose usage restriction is to be released (hereinafter referred to as “object to be released”). This eliminates the need of designate the object to be released. This arrangement eliminates the possibility of an operation error of incorrectly designating the object that cannot be released by the inputted release information. This signifies improved maneuverability.

According to another aspect of the preferred embodiment of the present invention, each of the first release information and second release information is generated from a common piece of source information. These pieces of release information are obtained, and the designation of object to be released is received, whereby a decision is made to determine if the usage restriction can be released or not. Two pieces of release information are each generated by different transformation processing. This makes it more difficult to achieve illegal identification of the transformation/inverse transformation correspondence between the first release information and second release information. This arrangement further reduces the possibility of releasing the usage restriction, using the illegally generated release information.

According to another aspect of the preferred embodiment of the present invention, each of the first release information and second release information is generated from a common piece of source information. These pieces of release information are obtained, and the object to be released is automatically selected. Two pieces of release information are each generated by different transformation processing. This makes it more difficult to achieve illegal identification of the transformation/inverse transformation correspondence between the first release information and second release information. This arrangement further reduces the possibility of releasing the usage restriction, using the illegally generated release information.

According to another aspect of the preferred embodiment of the present invention, when the third release information obtained by applying predetermined transformation processing to the first release information matches the second release information, the usage restriction of the predetermined function is released.

According to another aspect of the preferred embodiment of the present invention, the first release information is stored in semiconductor device, and the first obtaining section acquires the first release information from this mounted semiconductor device. It is possible to use any type of semiconductor device, such as a small integrated circuit called the one-chip microcomputer with a built-in memory or a flash memory. The number of the pieces of the first release information stored in the semiconductor device can be one or more than one.

When the first release information is stored in the semiconductor device, the semiconductor device can be used as a physical key. For example, even of two pieces of release information have leaked, usage restriction release is disabled if the semiconductor device conforming to the information processing apparatus cannot be obtained. This arrangement improves the security against illegal release. Further, the physical key can be sealed in a packing case or stored in a warehouse that only an authorized person can enter. This arrangement improves the security of the first release information stored inside. Improved security is also ensured by the advantage that the possibility of illegal acquisition of release information is substantially reduced.

When two optional functions are incorporated, each of the optional functions are separately released in response to the difference in the transformation/inverse transformation correspondence of the two pieces of release information having been obtained. This eliminates the need of identifying the object to be released, by using a different type of semiconductor device for each optional function or by changing the method of installation (installation position). This makes it possible to standardize the semiconductor device, with the result that the cost is reduced. Since there is no need of identifying the semiconductor device for every object to be released, management after the purchase is facilitated. This arrangement also makes it possible to standardize the method of installing the semiconductor device, and therefore, the risk of apparatus damage due to operation error can be avoided.

According to another aspect of the preferred embodiment of the present invention, proper identification information for uniquely specifying each semiconductor device is stored in each of the semiconductor devices. This proper identification information is adopted as the first release information. Each piece of the proper identification information is different from another, so there is only one second release information in the transformation/inverse transformation correspondence with a certain first release information. This arrangement ensures that, even if a plurality of semiconductor devices have been illegally acquired, usage restriction is not released if the second release information having a transformation/inverse transformation correspondence with the first release information stored inside is not acquired. Thus, this arrangement improves the security against illegal release, as compared with the case wherein the common first release information is used in all the information processing apparatuses.

If arrangements are made in such a way that the semiconductor device storing the serial number in advance is purchased, it is possible to omit the step of generating the proper identification information independently or storing this information into each semiconductor device, thereby improving the efficiency in generating release information.

According to another aspect of the preferred embodiment of the present invention, the first release information is stored in the information processing apparatus in advance. A predetermined usage restriction can be released merely by obtaining the second release information corresponding to the first release information stored in advance. This ensures a simplified operation for releasing the usage restriction.

When proper identification information as the first release information is stored in advance, the usage restriction on the object to be released can be released only when the unique second release information corresponding thereto. This avoids the risk of illegal release of the usage restriction on a plurality of information processing apparatuses, using one piece of the second release information.

Especially when the maintenance of the serial number and others assigned to the controller of the object to be released, and parts replacement thereof are placed under separate management, the serial number and others should be stored as proper identification information (the first release information) is stored in the storage section. If the information managed for a different purpose is used as the first release information, there is no need of generating the first release information independently and storing it into the information processing apparatus. This arrangement saves the time and labor for a long-term management of the first release information for the sole purpose of independent generation of the first release information or generation of the second release information.

It is to be noted that various changes and modifications will be apparent to those skilled in the art. Therefore, unless such changes and modifications depart from the scope of the present invention, they should be construed as being included therein.

What is claimed is:

1. An information processing apparatus which has a predetermined function under usage restriction condition, comprising:
a first obtaining section to obtain first release information;
a second obtaining section to obtain second release information;
an inverse-transformation section to process the second release information by using a inverse-transformation inverse to a predetermined transformation so as to generate third release information;
a comparison section to compare the third release information with the first release information; and
a release section to release the predetermined function under usage restriction condition in case the third release information matches the first release information.

2. The apparatus of claim 1, wherein the first obtaining section obtains the first release information from a removable semiconductor device equipped with the apparatus.

3. The apparatus of claim 2, wherein the first release information is proper identification information.

4. The apparatus of claim 1, wherein the first release information is stored in a storage section, and the stored first release information is used.

5. The apparatus of claim 1, wherein the apparatus is an image forming apparatus.

6. The apparatus of claim 5, wherein the function under usage restriction condition includes facsimile function.

7. An information processing apparatus which has a first function and a second function under usage restriction condition, comprising:
a first obtaining section to obtain first release information;
a second obtaining section to obtain second release information;
a designation section to designate a function to be released;
an inverse-transformation section to process the second release information by using a first inverse-transformation inverse to a first transformation when the first function is designated at the designation section, to process the second release information by using a second inverse-transformation inverse to a second transformation when the second function is designated at the designation section, and to generate third release information by the inverse-transformation;
a comparison section to compare the third release information with the first release information; and
a release section to release the designated function under usage restriction condition in case the third release information matches the first release information.

8. The apparatus of claim 7, wherein the first obtaining section obtains the first release information from a removable semiconductor device equipped with the apparatus.

9. The apparatus of claim 8, wherein the first release information is proper identification information.

10. The apparatus of claim 7, wherein the first release information is stored in a storage section, and the stored first release information is used.

11. The apparatus of claim 7, wherein the apparatus is an image forming apparatus.

12. The apparatus of claim 11, wherein the function under usage restriction condition includes facsimile function.

13. An information processing apparatus which has a first function and a second function under usage restriction condition, comprising:
a first obtaining section to obtain first release information;
a second obtaining section to obtain second release information;
an inverse-transformation section to process the second release information by using a first inverse-transformation inverse to a first transformation or a second inverse-transformation inverse to a second transformation, and to generate third release information by the inverse-transformation;
a comparison section to compare the third release information with the first release information; and
a release section to release the first function under usage restriction condition in case the third release information obtained by the first inverse-transformation matches the first release information, and to release the second function under usage restriction condition in case the third release information obtained by the second inverse-transformation matches the first release information.

14. The apparatus of claim 13, wherein the first obtaining section obtains the first release information from a removable semiconductor device equipped with the apparatus.

15. The apparatus of claim 14, wherein the first release information is proper identification information.

16. The apparatus of claim 13, wherein the first release information is stored in a storage section, and the stored first release information is used.

17. The apparatus of claim 13, wherein the apparatus is an image forming apparatus.

18. The apparatus of claim 17, wherein the function under usage restriction condition includes facsimile function.

19. An information processing apparatus which has a first function and a second function under usage restriction condition, comprising:
a first obtaining section to obtain first release information generated from an original information by a first transformation or a second transformation;
a second obtaining section to obtain second release information generated from the original information by a third transformation or a fourth transformation;
a designation section to designate a function to be released;
an inverse-transformation section to process the first release information by using a first inverse-transformation inverse to the first transformation and the second release information by using a third inverse-transformation inverse to the third transformation when the first function is designated at the designation section, to process the first release information by using a second inverse-transformation inverse to a second transformation and the second release information by using a fourth inverse-transformation inverse to the fourth transformation when the second function is designated at the designation section, and to generate third release information and fourth release information by the inverse-transformation;
a comparison section which compare the third release information with the fourth release information; and
a release section to release the designated function under usage restriction condition in case the third release information matches the fourth release information.

20. The apparatus of claim 19, wherein the first obtaining section obtains the first release information from a removable semiconductor device equipped with the apparatus.

21. The apparatus of claim 20, wherein the first release information is proper identification information.

22. The apparatus of claim 19, wherein the first release information is stored in a storage section, and the stored first release information is used.

23. The apparatus of claim 19, wherein the apparatus is an image forming apparatus.

24. The apparatus of claim 23, wherein the function under usage restriction condition includes facsimile function.

25. An information processing apparatus which has a first function and a second function under usage restriction condition, comprising:
a first obtaining section to obtain first release information generated from an original information by a first transformation or a second transformation;
a second obtaining section to obtain second release information generated from the original information by a third transformation or a fourth transformation;
an inverse-transformation section to process the first release information by using a first inverse-transformation inverse to the first transformation or a second inverse-transformation inverse to a second transformation, to process the second release information by using a third inverse-transformation inverse to the third transformation or a fourth inverse-transformation inverse to the fourth transformation, and to generate third release information and fourth release information by the inverse-transformation;
a comparison section to compare the third release information with the fourth release information; and
a release section to release the first function under usage restriction condition in case the third release information obtained by the first inverse-transformation matches the fourth release information obtained by the third inverse-transformation, and to release the second function under usage restriction condition in case the third release information obtained by the second inverse-transformation matches the fourth release information obtained by the fourth inverse-transformation.

26. The apparatus of claim 25, wherein the first obtaining section obtains the first release information from a removable semiconductor device equipped with the apparatus.

27. The apparatus of claim 26, wherein the first release information is proper identification information.

28. The apparatus of claim 25, wherein the first release information is stored in a storage section, and the stored first release information is used.

29. The apparatus of claim 25, wherein the apparatus is an image forming apparatus.

30. The apparatus of claim 29, wherein the function under usage restriction condition includes facsimile function.

31. An information processing apparatus which has a predetermined function under usage restriction condition, comprising:
a first obtaining section to obtain first release information;
a second obtaining section to obtain second release information;
a transformation section to process the first release information by using a predetermined transformation so as to generate third release information;
a comparison section to compare the third release information with the second release information; and
a release section to release the predetermined function under usage restriction condition in case the third release information matches the second release information.

32. The apparatus of claim 31, wherein the first obtaining section obtains the first release information from a removable semiconductor device equipped with the apparatus.

33. The apparatus of claim 32, wherein the first release information is proper identification information.

34. The apparatus of claim 31, wherein the first release information is stored in a storage section, and the stored first release information is used.

35. The apparatus of claim 31, wherein the apparatus is an image forming apparatus.

36. The apparatus of claim 35, wherein the function under usage restriction condition includes facsimile function.
